(19) United States
(12) Patent Application Publication
(10) Pub. No.: US 2026/0330775 A1
(43) Pub. Date: Oct. 22, 2026

(54) CONTROL SYSTEM, CONTROL METHOD, AND RECORDING MEDIUM

(71) Applicant: NEC CORPORATION, Minato-ku, Tokyo (JP)

(72) Inventors: Yuki TSURUOKA, Tokyo (JP); Yushi Niwa, Tokyo (JP); Takashi MIYAKE, Tokyo (JP); Akihiko ONITA, Tokyo (JP)

(73) Assignee: NEC CORPORATION, Minato-ku, Tokyo (JP)

(21) Appl. No.: 19/108,924

(22) PCT Filed: Nov. 18, 2022
(86) PCT No.: PCT/JP2022/042806

§ 371 Date: Mar. 5, 2025

(51) Int. Cl. G06T 19/00; G06F 3/01

(52) U.S. Cl. CPC G06T 19/006; G06F 3/011

(57) ABSTRACT

A control system comprising: a memory storing instructions; and at least one processor configured to execute the instructions to: acquire data in which imaging device identification information for identifying an imaging device installed in a real space is associated with frame identification information for identifying a frame in a virtual reality space; generate, from a video captured by an imaging device identified by the imaging device identification information associated with the frame identification information for identifying the frame based on a positional relationship in the virtual reality space between a user in the virtual reality space and the frame, a video of the frame seen by the user in the virtual reality space; and display the generated video of the frame in the frame displayed on a display device.

### TECHNICAL FIELD

The present disclosure relates to a control system and the like.

### BACKGROUND ART

In the virtual reality space, a video of the real space may be displayed.

For example, PTL 1 describes that an image is displayed on a head mounted display (HMD). Specifically, PTL 1 describes that an image displayed on the HMD includes a virtual reality space or an augmented reality space in which an internal space and a scene viewed from a tourist mobile object are synthesized, and a character, and the scene viewed from the tourist mobile object is synthesized with a window of a mobile unit.

PTL 2 describes capturing a conversation partner with a virtual camera in order to have an interaction and displaying a captured video on a virtual window in a virtual reality space.

### CITATION LIST

### Patent Literature

PTL 1: JP 2021-058528 A

PTL 2: WO 2022/091832 A 1

### SUMMARY OF INVENTION

### Technical Problem

For example, in a virtual reality space, when a scene viewed from a frame such as a window or a door of a building or a vehicle is a fixed viewpoint, there is a problem that a realistic feeling is low.

An object of the present disclosure is to provide a control system and the like that improve a realistic feeling.

### Solution to Problem

A control system according to an aspect of the present disclosure includes an acquisition means for acquiring data in which imaging device identification information for identifying an imaging device installed in a real space is associated with frame identification information for identifying a frame in a virtual reality space, a generation means for generating, from a video captured by an imaging device identified by the imaging device identification information associated with the frame identification information for identifying the frame based on a positional relationship in the virtual reality space between a user in the virtual reality space and the frame, a video of the frame seen by the user in the virtual reality space, and an output control means for displaying the generated video of the frame in the frame displayed on a display device.

A control method according to an aspect of the present disclosure includes acquiring data in which imaging device identification information for identifying an imaging device installed in a real space is associated with frame identification information for identifying a frame in a virtual reality space, generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame, and displaying the generated video of the frame in the frame displayed on a display device.

A program according to an aspect of the present disclosure causes a computer to execute the steps of acquiring data in which imaging device identification information for identifying an imaging device installed in a real space is associated with frame identification information for identifying a frame in a virtual reality space, generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame, and displaying the generated video of the frame in the frame displayed on a display device.

The program may be stored in a non-transitory computer-readable recording medium.

### Advantageous Effects of Invention

According to the present disclosure, it is possible to improve a realistic feeling.

### BRIEF DESCRIPTION OF DRAWINGS

FIG. 1 is a block diagram illustrating a configuration example of a control system according to the first example embodiment.

FIG. 2 is a flowchart illustrating an operation example of the control system according to the first example embodiment.

FIG. 3 is an explanatory diagram illustrating an example of a dome display used as a display device.

FIG. 4 is an explanatory diagram illustrating an example of connection between a control system and a dome display or the like.

FIG. 5 is an explanatory diagram illustrating an example of an HMD used as a display device.

FIG. 6 is an explanatory diagram illustrating an example of connection between a control system and an HMD or the like.

FIG. 7 is an explanatory view illustrating an example of a seat of a mobile object.

FIG. 8 is a block diagram illustrating a configuration example of a control system according to the second example embodiment.

FIG. 9 is an explanatory diagram illustrating an example in which an imaging device is installed in a mobile object.

FIG. 10 is an explanatory diagram illustrating an example of a correspondence between one imaging device in real space and a window in virtual reality space.

FIG. 11 is an explanatory diagram illustrating an example of an association table in which an imaging device and a window are associated with each other.

FIG. 12 is an explanatory diagram illustrating an example of cutting out a video of a window from a captured video.

FIG. 13 is an explanatory diagram illustrating an example in which a plurality of imaging devices is installed in a mobile object.

FIG. 14 is an explanatory diagram illustrating an example of a correspondence relationship between two imaging devices in a real space and a window in a virtual reality space.

FIG. 15 is an explanatory diagram illustrating an example of an association table in which a plurality of imaging devices and windows is associated with each other.

FIG. 16 is an explanatory diagram illustrating an example of generating a video of a window from videos captured by each of a plurality of imaging devices.

FIG. 17 is an explanatory diagram illustrating an example of selecting and generating a video of a window from videos captured by each of a plurality of imaging devices.

FIG. 18 is an explanatory diagram illustrating a display example of the dome display.

FIG. 19 is an explanatory diagram illustrating an example of graphically displaying the voice of another user.

FIG. 20 is an explanatory diagram illustrating an example of switching from graphic output to sound output.

FIG. 21 is a flowchart illustrating an operation example of the control system according to the second example embodiment.

FIG. 22 is an explanatory diagram illustrating a hardware configuration example of a computer.

### EXAMPLE EMBODIMENT

Hereinafter, example embodiments of a control system, a control method, a program, and a non-transitory recording medium recording the program according to the present disclosure will be described in detail with reference to the drawings. The present example embodiment does not limit the disclosed technology.

Virtual reality may be referred to as virtual reality (VR). In the control system, for example, a virtual reality space is displayed on the display device. The type of the display device is not particularly limited, and examples thereof include an HMD and a dome display. The use scene of the virtual reality space is not particularly limited.

### First Example Embodiment

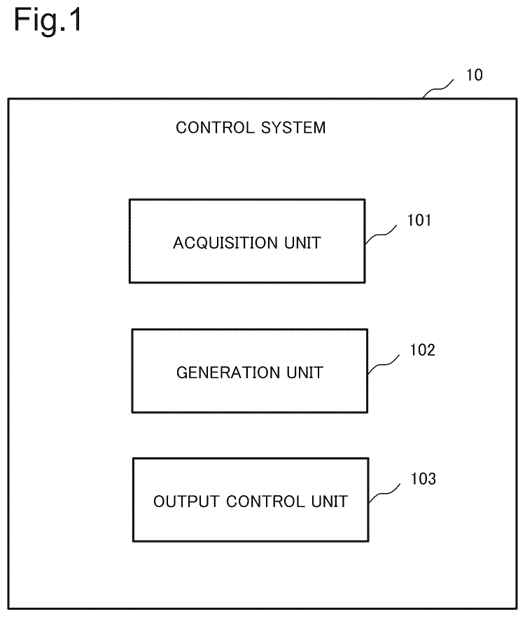

First, in the first example embodiment, a basic function of the control system will be described. FIG. 1 is a block diagram illustrating a configuration example of a control system according to the first example embodiment. For example, a control system 10 includes an acquisition unit 101, a generation unit 102, and an output control unit 103.

The acquisition unit 101 acquires data in which imaging device identification information for identifying an imaging device installed in the real space is associated with frame identification information for identifying a frame in the VR space. The type of the imaging device is not particularly limited, but a 360-degree camera or the like may be used. As a specific data acquisition method, the acquisition unit 101 may acquire, from the database, data in which frame identification information for identifying a frame in the VR space that can be visually recognized by the user in the VR space is associated with imaging device identification information for identifying an imaging device installed in the real space. Alternatively, the acquisition unit 101 may acquire data via an input device or a communication network. For example, the frame may be a frame of a vehicle or a frame of a building in the VR space. The vehicle is not particularly limited, and examples thereof include a bus, an airplane, a train, and a ship. The building is not particularly limited, and examples thereof include a company, a school, and a house. Examples of the frame include a window and a door. In the following description, associating the frame identification information with the imaging device identification information may be expressed as associating the frame with the imaging device in order to simplify the description. In order to simplify the description, the imaging device identified by the imaging device identification information associated with the frame identification information for identifying the frame in the VR space may be referred to as an imaging device associated with the frame.

Next, based on the positional relationship in the VR space between the user in the VR space and the frame in the VR space, the generation unit 102 generates a video of a frame seen by the user in the VR space from the video captured by the imaging device associated with the frame. Examples of the positional relationship here include a distance from the frame, a height position, and a position in a horizontal direction with respect to the frame such as left and right. A specific video generation method will be described in detail in the second example embodiment.

The output control unit 103 displays the video of the generated frame in the frame in the VR space displayed on the display device.

### Flowchart

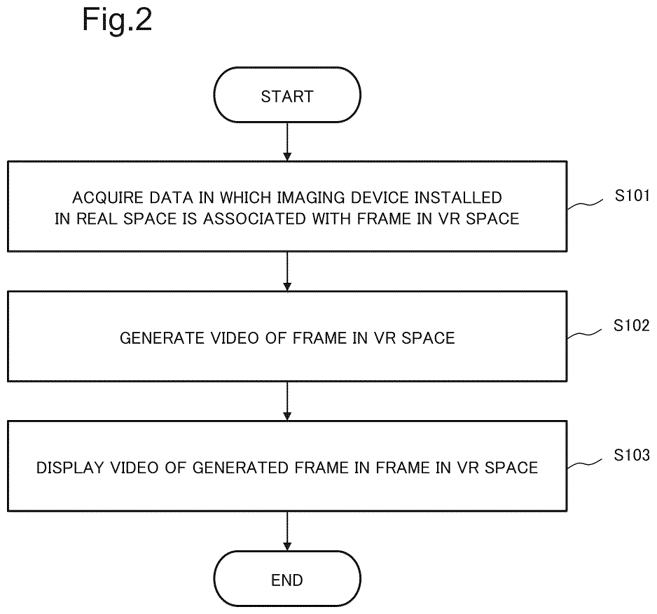

FIG. 2 is a flowchart illustrating an operation example of the control system 10 according to the first example embodiment. The acquisition unit 101 acquires data in which the imaging device installed in the real space is associated with the frame in the VR space (step S101).

The generation unit 102 generates the video of the frame in the VR space from the video captured by the imaging device associated with the frame in the VR space based on the positional relationship in the VR space between the user in the VR space and the frame in the VR space (step S102). The output control unit 103 displays the generated video of the frame in the frame in the VR space (step S103).

In a real space, a scene viewed from a frame such as a window or a door of a building or a vehicle varies depending on a position of a user. For example, in a VR space, a scene viewed from a frame such as a window or a door of a building, a window or a door of a vehicle, or the like may be a fixed viewpoint. In such a case, there is a problem that the realistic feeling is low. In the first example embodiment, the control system 10 generates the video of the frame in the VR space seen by the user in the VR space from the video captured by the imaging device associated with the frame in the VR space based on the positional relationship in the VR space between the user in the VR space and the frame in the VR space. The control system 10 displays the generated video of the frame in the frame in the VR space. As a result, it is possible to provide a video of the real space that can be seen from the position of the user in the VR space. Therefore, it is possible to improve the realistic feeling.

### Second Example Embodiment

Next, the second example embodiment will be described in detail with reference to the drawings. In the second example embodiment, an imaging device is installed at a mobile object in a real space, and a travel is taken as an example of a use scene of a VR space, and a vehicle window is taken as an example of a frame in the VR space. Hereinafter, description of content overlapping with the above description will be omitted to the extent that the description of the second example embodiment is not unclear.

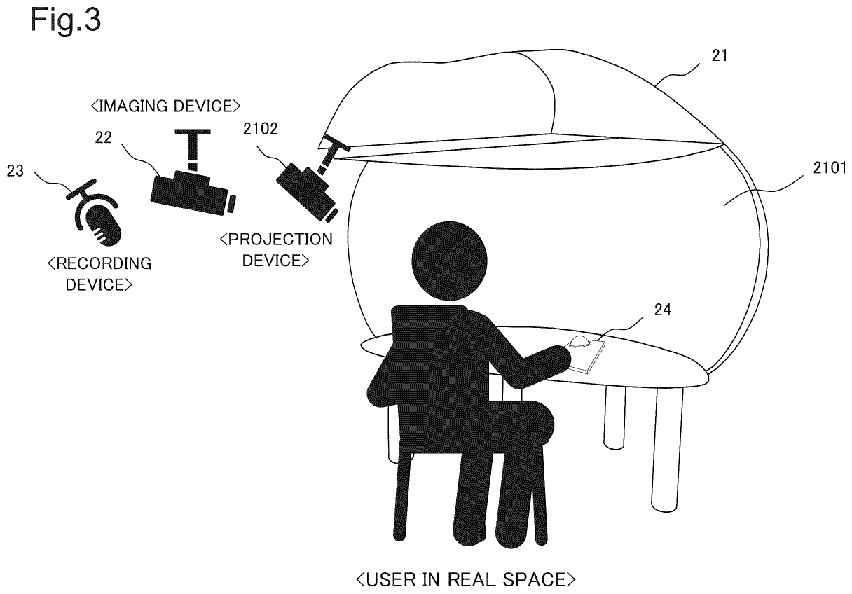

FIG. 3 is an explanatory diagram illustrating an example of a dome display used as a display device. In FIG. 3, a dome display 21 is taken as an example of the display device. In the real space, for example, the user sits in front of the dome display 21.

The dome display 21 displaying a video means that a projection device 2102 projects a video on a screen 2101.

An imaging device 22 and a recording device 23 may be installed at a place where the dome display 21 is installed. For example, the imaging device 22 and the recording device 23 are used to detect the orientation of the face of the user, the line-of-sight orientation of the user, the movement of the user, and the conversation of the user. The control system can detect the position of the user and the movement of the user from the video captured by the imaging device 22. The control system can detect the conversation of the user from the sound obtained by the recording device 23. Although not illustrated, a sound output device such as a speaker that outputs a voice of another user or a voice in a mobile object is installed at a place where the dome display 21 is installed. A controller 24 may be installed at a place where the dome display 21 is installed. The controller 24 is an example of an input device that receives a user's operation, for example. For example, in the second example embodiment, the controller 24 receives an input of movement of the user by an operation by the user.

The number of each of the imaging device 22 and the recording device 23 is not particularly limited. For example, the imaging device 22 may transmit the captured video to a control system or the like. The recording device 23 may transmit a sound to a control system or the like.

The dome display 21 is, for example, a device having a structure in which at least part of the screen 2101 is a curved surface and covers the field of view of the user. The dome display 21 may not have a complete dome shape with 360 degrees, but may have a shape with 180 degrees with part thereof missing. That is, the dome display 21 may have a hemispherical dome shape. In the dome display 21, part of the screen 2101 may not be curved. As described above, the size and type of the dome display 21 are not particularly limited. For example, the dome display 21 may be a 180 degree dome display 21 or a 360 degree dome display 21. For example, the size of the dome display 21 may be about one meter to two meters in height, one meter to two meters in width, and one meter to two meters in height.

The installation location of the dome display 21 is not particularly limited. For example, the dome display 21 may be installed in a user's house, company, or the like, or may be installed in a place that can be used by anyone.

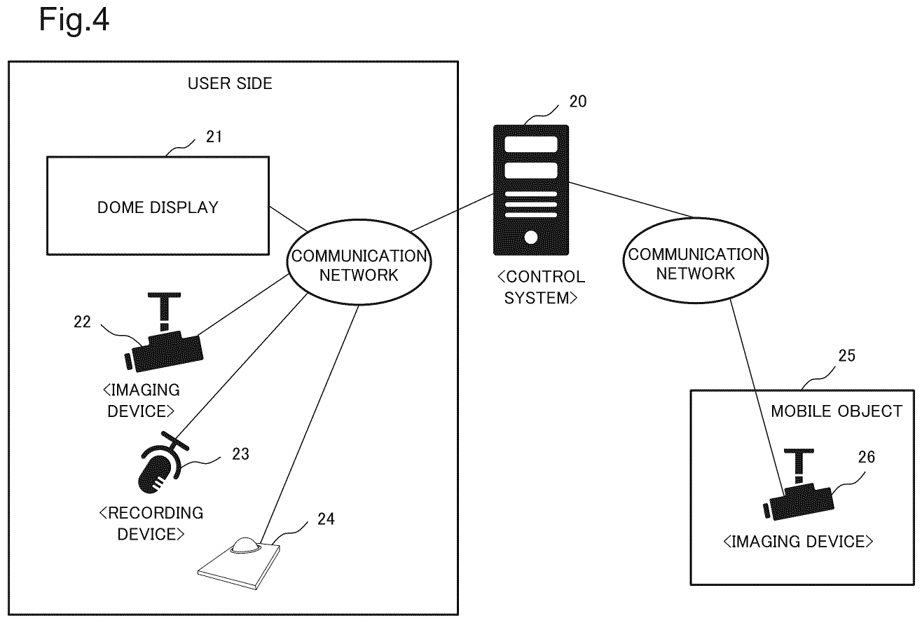

FIG. 4 is an explanatory diagram illustrating an example of connection between the control system and the dome display 21 or the like. The dome display 21, the imaging device 22, the recording device 23, and the controller 24 are installed in a house, a shared space, or the like of the user. The control system 20 is connected to the dome display 21, the imaging device 22, the recording device 23, the controller 24, and the like via a communication network. For example, an edge terminal device or the like may be installed on the user side. The edge terminal device may be connected to the dome display 21, the imaging device 22, the recording device 23, the controller 24, and the like via the communication network, and the control system 20 may be connected to the edge terminal device via the communication network or the like.

For example, an imaging device 26 in the real space may be installed in a mobile object 25. The imaging device 26 may be attached to a robot arm or the like. The imaging device 26 is connected to the control system 20 via the communication network. The number of imaging devices 26 is not particularly limited.

The control system 20 may be configured as an entire system including the dome display 21, the imaging device 22, the recording device 23, the imaging device 26, and the controller 24.

The communication network in which the control system 20 is connected to the device of the user and the communication network in which the control system 20 is connected to the device of the mobile object 25 may be the same.

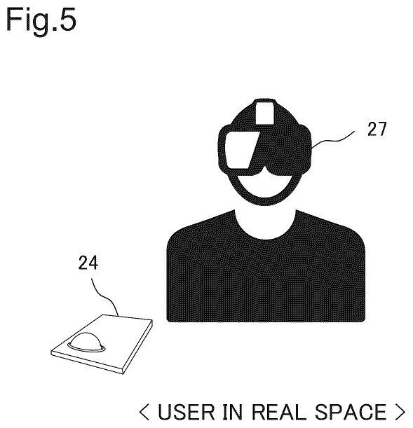

FIG. 5 is an explanatory diagram illustrating an example of an HMD used as a display device. In FIG. 5, an HMD 27 is taken as an example of the display device. In the real space, the user wears the HMD 27.

For example, the HMD 27 may have a function capable of detecting the face orientation of the user, the line-of-sight orientation of the user, and the movement of the user. The HMD 27 may also have a sound output function, a function of collecting sound, and the like. The controller 24 may be used to be able to input the motion of the user.

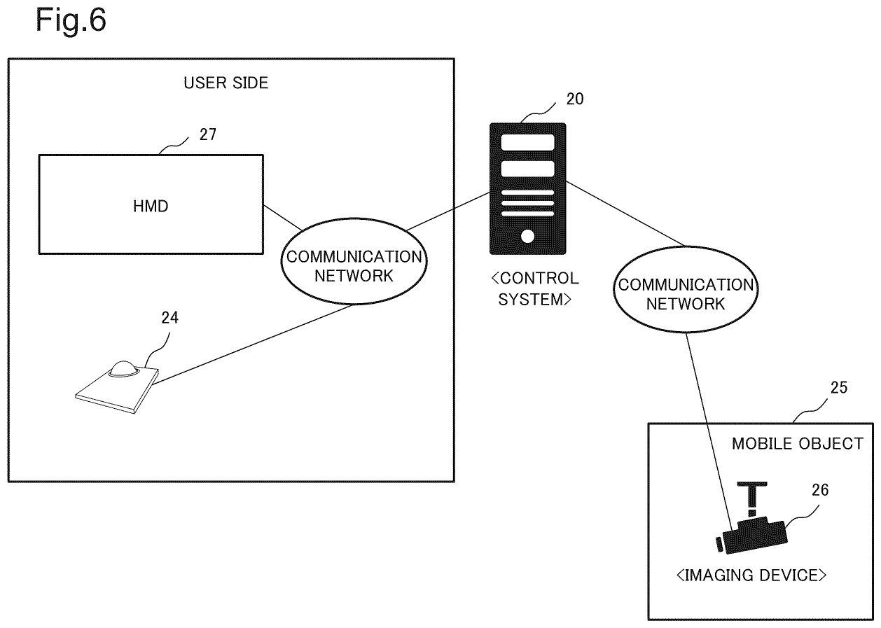

FIG. 6 is an explanatory diagram illustrating an example of connection between the control system 20 and the HMD 27 or the like. The control system 20 is connected to the HMD 27, the controller 24, and the like via a communication network. For example, an edge terminal device or the like may be installed on the user side. The edge terminal device may be connected to the HMD 27, the controller 24, and the like via the communication network, and the control system 20 may be connected to the edge terminal device via the communication network or the like.

For example, as in FIG. 4, the imaging device 26 is installed in the mobile object 25. The imaging device 26 may be attached to a robot arm or the like. The imaging device 26 is connected to the control system 20 via the communication network. The number of imaging devices 26 is not particularly limited.

The control system 20 may be configured as an entire system including the HMD 27, the imaging device 26, and the controller 24.

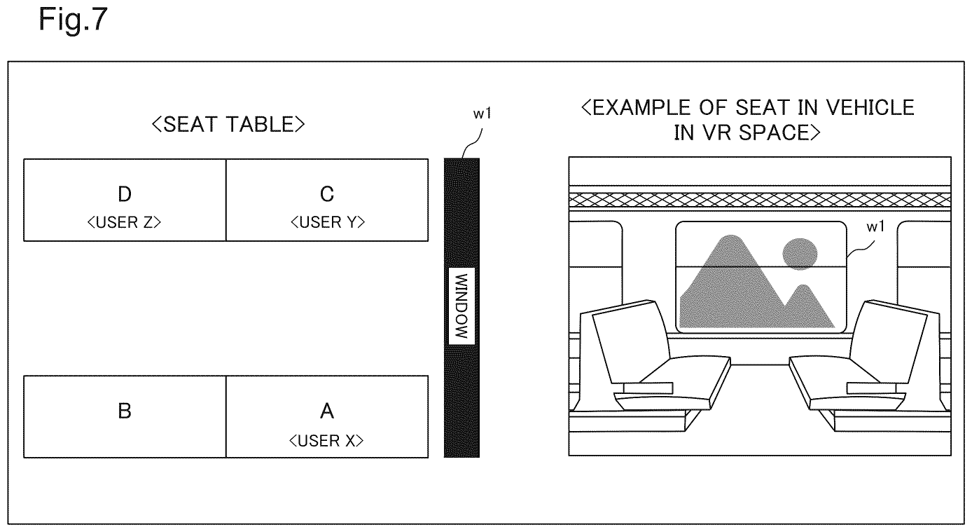

FIG. 7 is an explanatory diagram illustrating an example of a seat of the mobile object 25. In a case where a window w1 in the VR space is a window w1 of a vehicle such as a bus or a train, there may be a seat in the VR space. For example, in FIG. 7, there are seats A to D. The seat A is a seat of the user X. The seat B is a seat of the user Y. The seat C is a seat of the user Z.

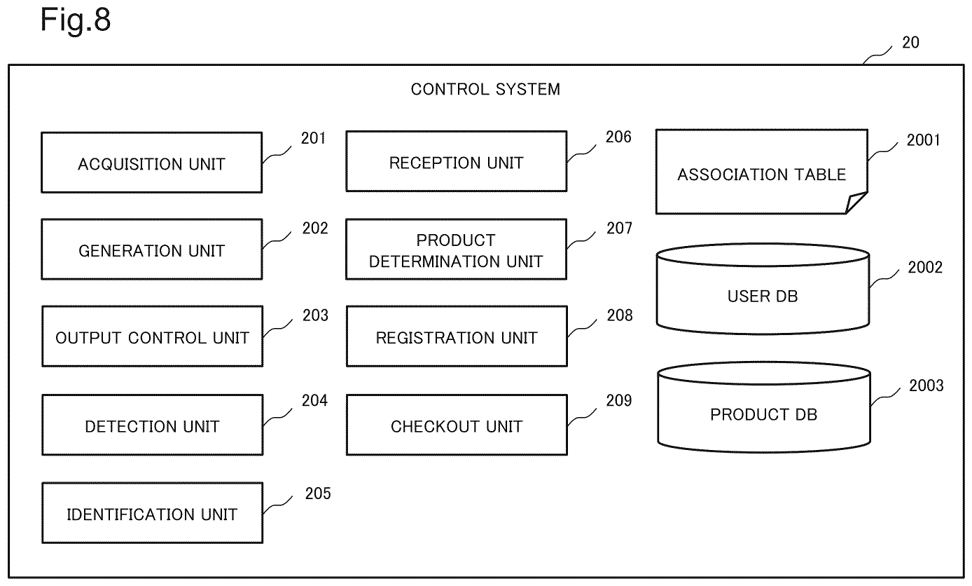

FIG. 8 is a block diagram illustrating a configuration example of the control system 20 according to the second example embodiment. For example, the control system 20 includes an acquisition unit 201, a generation unit 202, an output control unit 203, a detection unit 204, an identification unit 205, a reception unit 206, a product determination unit 207, a registration unit 208, and a payment unit 209.

The control system 20 is different from the control system 10 according to the first example embodiment in that the detection unit 204, the identification unit 205, the reception unit 206, the product determination unit 207, the registration unit 208, and the payment unit 209 are further included.

The acquisition unit 201 has the function of the acquisition unit 101 according to the first example embodiment as a basic function. The generation unit 202 has the function of the generation unit 102 according to the first example embodiment as a basic function. The output control unit 203 has the function of the output control unit 103 according to the first example embodiment as a basic function.

For example, the control system 20 includes an association table 2001, a user database (DB) 2002, and a product DB 2003. Each functional unit of the control system 20 can appropriately refer to and update various pieces of databases and tables.

The association table 2001 stores data that associates the imaging device 26 in the real space with the window in the VR space. Specifically, the association table 2001 stores, for example, imaging device identification information for identifying the imaging device 26 and window identification information for identifying the window in association with each other. The imaging device identification information only is required to be able to identify the imaging device 26, and the expression format of the imaging device identification information is not particularly limited. The expression format of the window identification information is not particularly limited as long as the window identification information can identify the window. A plurality of imaging devices 26 may be associated with one window. A storage example of the association table 2001 will be described later with reference to the drawings together with an installation example of the imaging device 26.

The user DB 2002 stores user information for each user. Examples of the user information include a name of the user, an image of the user, and the like. The image of the user may be an actual picture of the user or an avatar, and is not particularly limited. The image of the user is used as, for example, an image of the user in the VR space. For example, the user DB 2002 may store, for each user, display device identification information for identifying a display device and user information in association with each other. Further, the user DB 2002 may store the display device identification information, the user identification information for identifying the user, and the user information in association with each other.

The product DB 2003 stores product information for each product. The product DB 2003 stores product identification information and product information in association with each other. The product identification information is not particularly limited as long as the product can be identified. The product information is not particularly limited, and examples thereof include the name of the product, the price of the product, the image of the product, and the characteristic of the product.

Next, processing of each functional unit will be specifically described with an example of associating the imaging device 26 in the real space with the window in the VR space.

### <Example of Association Between One Imaging Device 26 and Window>

First, an example of associating one imaging device 26 in the real space with a window in the VR space will be described.

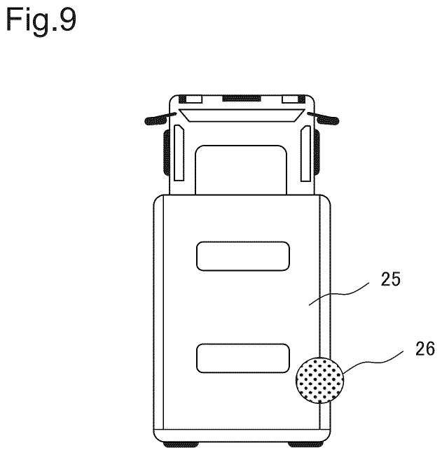

FIG. 9 is an explanatory diagram illustrating an example in which the imaging device 26 is installed in the mobile object 25. For example, in the real space, the imaging device 26 is installed in the mobile object 25. In FIG. 9, the mobile object 25 is exemplified by a vehicle such as a truck, but is not particularly limited, and examples thereof include an airplane, a train, a drone, a ship, and the like.

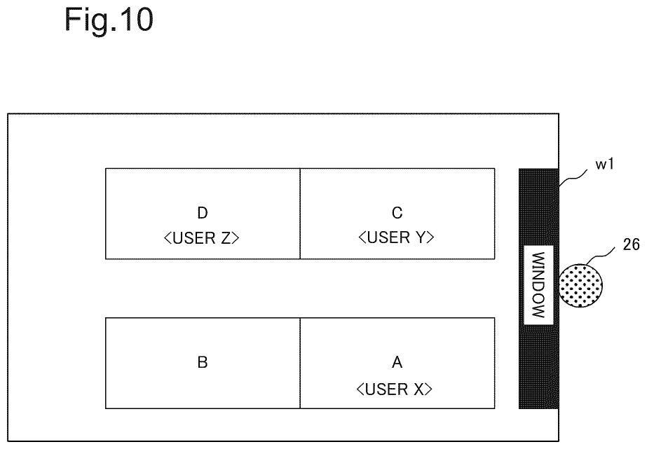

FIG. 10 is an explanatory diagram illustrating an example of a correspondence relationship between one imaging device 26 in the real space and a window in the VR space. Although the imaging device 26 in the real space is not installed in the window w1 in the VR space, in order to facilitate understanding, FIG. 10 illustrates a positional relationship between one imaging device 26 in the real space and the window w1 in the VR space.

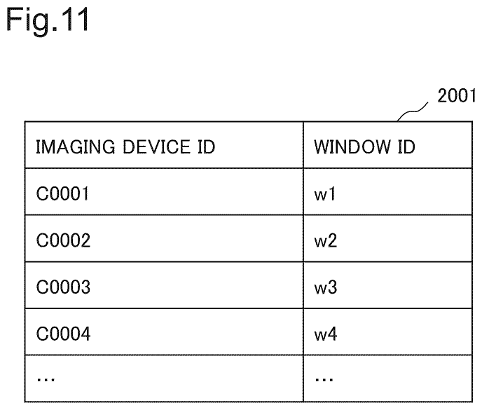

FIG. 11 is an explanatory diagram illustrating an example of the association table 2001 in which the imaging device 26 and the window are associated with each other. The association table 2001 stores an imaging device identifier (ID) and a window ID in association with each other. The imaging device ID is an example of imaging device identification information for identifying the imaging device 26. The window ID is an example of window identification information for identifying a window.

In FIG. 11, the imaging device ID “C0001” and the window ID “w1” are associated with each other. For example, the imaging device identified by the imaging device ID “C0001” is the imaging device 26 illustrated in FIG. 9. The imaging device ID “C0002” and the window ID “w2” are associated with each other. The imaging device ID “C0003” and the window ID “w3” are associated with each other. The imaging device ID “C0004” and the window ID “w4” are associated with each other.

The association table 2001 may store position information and place information indicating where the imaging device 26 is installed in the real space, orientation information indicating in what orientation the imaging device is installed in the real space, and the like in association with the imaging device ID.

For example, the acquisition unit 201 acquires the association table 2001 as data in which the imaging device 26 installed in the real space is associated with a window in the VR space.

Next, based on the positional relationship in the VR space between the user in the VR space and the window in the VR space, the generation unit 202 generates a video of the window seen by the user in the VR space from the video captured by the imaging device 26 associated with the window.

In a case where there is a plurality of users, for example, the generation unit 202 generates, for each of the plurality of users, a video of a window seen by the user in the VR space from the video captured by the camera based on a positional relationship in the VR space between the user in the VR space and the window in the VR space.

The generation unit 202 generates a new video of a frame seen by the user in the VR space based on the positional relationship between the position of the user in the VR space and the position of the window in the VR space and the orientation of the user in the VR space. The orientation of the user is, for example, the orientation of the user's face or head, the line-of-sight orientation of the user, or the like.

Specifically, as a method of generating the video of the window, for example, the generation unit 202 may cut out the video of the window seen by the user in the VR space from the captured video based on the positional relationship in the VR space between the user in the VR space and the window in the VR space.

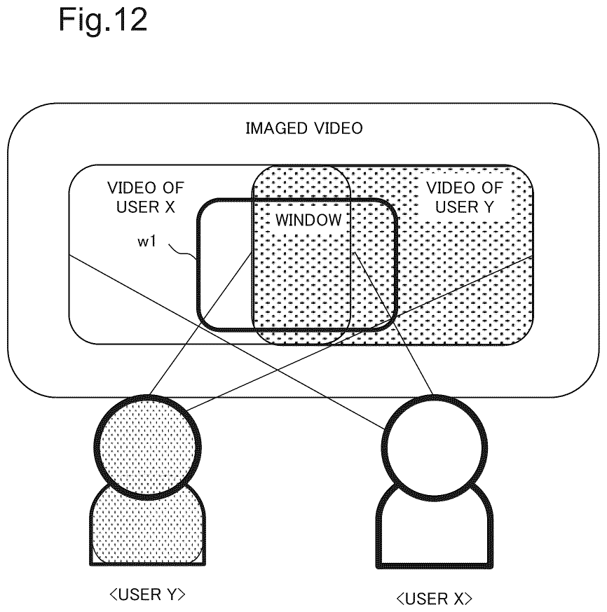

FIG. 12 is an explanatory diagram illustrating an example of cutting out a video of a window from a captured video. In FIG. 12, the generation unit 202 cuts out the video of the window w1 seen by the user X in the VR space from the captured video based on the positional relationship in the VR space between the user X in the VR space and the window w1 in the VR space and the line-of-sight orientation of the user.

In FIG. 12, the generation unit 202 cuts out the video of the window w1 seen by the user X in the VR space from the captured video based on the positional relationship in the VR space between the user X in the VR space and the window w1 in the VR space and the line-of-sight orientation of the user.

As another method of generating the video of the window, for example, the generation unit 202 generates a new video of a frame seen by the user in the VR space from the video captured by the imaging device 26 based on the positional relationship in the VR space between the user in the VR space and the window w1 in the VR space. Generating a new video may mean adding another video to a captured video. More specifically, for example, the generation unit 202 may generate a new video in such a way as to complement a captured video with a video that cannot be seen due to the weather. The generation unit 202 may synthesize another video, a character, or the like with the captured video without being limited to the synthesis, correction, and complement of the past video.

The video generation methods may be combined.

### <Example of Association Between Plurality of Imaging Devices 26 and Window>

Next, an example of associating a plurality of imaging devices 26 in the real space with a window in the VR space will be described.

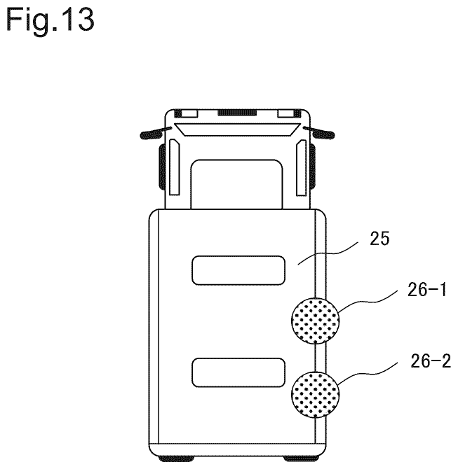

FIG. 13 is an explanatory diagram illustrating an example in which a plurality of imaging devices 26 is installed in the mobile object 25. For example, in the real space, two imaging devices 26-1 and 26-2 are installed at different positions in the mobile object 25.

In a case where the imaging device 26 is a camera other than the 360-degree camera, the imaging devices 26-1 and 26-2 may be installed at the same position and in different orientations.

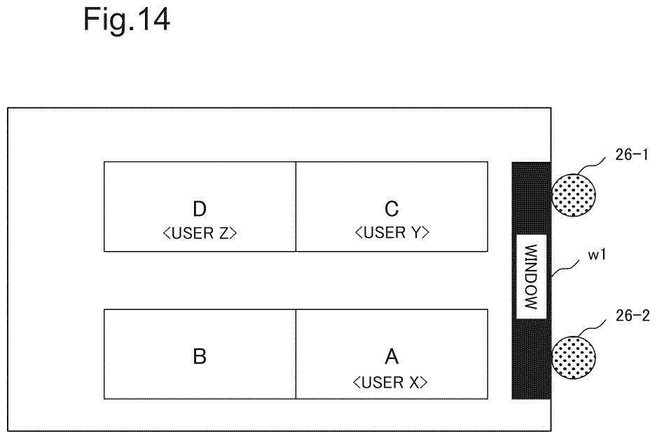

FIG. 14 is an explanatory diagram illustrating an example of a correspondence relationship between two imaging devices 26 in the real space and a window in the VR space. Although the imaging device 26 is not installed in the window w1 in the VR space, for easy understanding, FIG. 14 illustrates a positional relationship between the two imaging devices 26-1 and 26-2 in the real space and the window w1 in the VR space.

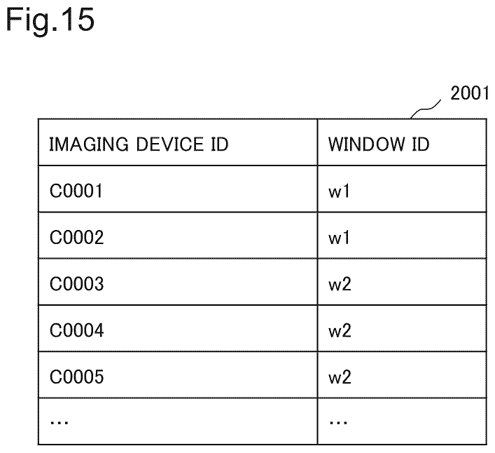

FIG. 15 is an explanatory diagram illustrating an example of an association table 2001 in which a plurality of imaging devices 26 and the window are associated with each other. The association table 2001 stores an imaging device identifier (ID) and a window ID in association with each other. As in the example of the association table 2001 of FIG. 11, in FIG. 15, the imaging device ID is an example of imaging device identification information for identifying the imaging device 26. The window ID is an example of window identification information for identifying a window.

In FIG. 15, in association table 2001, the imaging device ID “C0001” and the window ID “w1” are associated with each other, and the imaging device ID “C0002” and the window ID “w1” are associated with each other. For example, the imaging device identified by the imaging device ID “C0001” is the imaging device 26-1 illustrated in FIG. 13, and the imaging device identified by the imaging device ID “C0002” is the imaging device 26-2 illustrated in FIG. 13.

The association table 2001 may store position information and place information indicating where each of the plurality of imaging devices 26 is installed in the real space, orientation information indicating in what orientation in the real space, and the like in association with the imaging device ID.

Next, the acquisition unit 201 acquires the association table 2001 as data in which a plurality of imaging devices 26 installed at different positions in the real space and one window in the VR space are associated with each other.

Based on the positional relationship in the VR space between the user in the VR space and the window in the VR space, the generation unit 202 generates a video from the videos captured by the plurality of imaging devices 26 associated with the window in the association table 2001. The plurality of imaging devices 26 associated with the window in the association table 2001 is the plurality of imaging devices 26 identified by the plurality of imaging device IDs associated with the window ID in the association table 2001.

For example, the generation unit 202 generates a video seen by the user in the VR space from the plurality of videos based on the positional relationship in the VR space between the user in the VR space and the window in the VR space. Specifically, as a method of generating a video seen by the user from a plurality of videos, the generation unit 202 may synthesize a plurality of videos and cut out a video seen by the user in the VR space from the synthesized video. In a case where the window is large, by installing a large number of imaging devices 26 in such a way as to increase the density, the generation unit 202 can synthesize a plurality of videos to generate a finer video. As another method, the generation unit 202 may cut out a video seen by the user in the VR space from each of the plurality of videos, and synthesize the plurality of cut out videos to generate a video seen by the user in the VR space. Specifically, for example, the generation unit 202 may determine a coordinate position to be cut out from each of the plurality of videos, and synthesize the plurality of videos based on the determined coordinate position. In a case where the window is small, when the density is not high and a plurality of imaging devices is installed, it is not necessary to synthesize video portions that the user does not see, so that the generation unit 202 can generate a new video of the window seen by the user in the VR space in a short time.

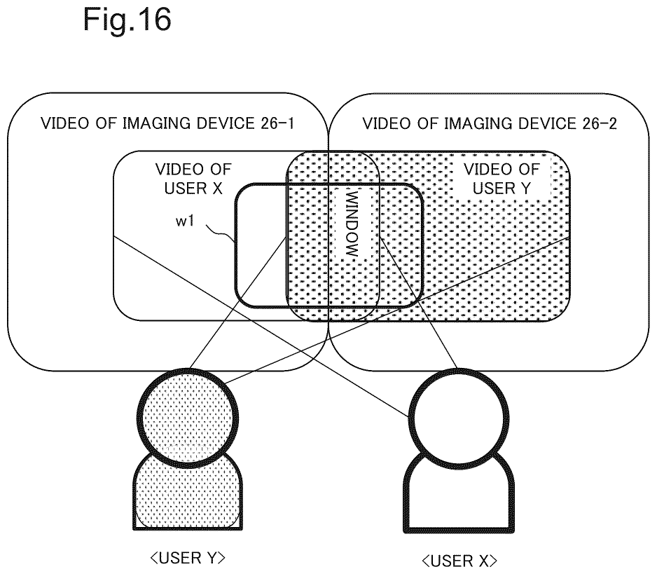

FIG. 16 is an explanatory diagram illustrating an example of generating a video of a window from videos captured by the plurality of imaging devices 26. In FIG. 16, the generation unit 202 generates a video seen by the user X in the VR space from the videos captured by the plurality of imaging devices 26 based on the positional relationship in the VR space between the user X in the VR space and the window w1 in the VR space and the line-of-sight orientation of the user. In FIG. 16, the generation unit 202 generates a video seen by the user X in the VR space from the video captured by the imaging device 26-1 and the video captured by the imaging device 26-2. FIG. 16 illustrates an example in which the ranges in which the plurality of videos captured by the imaging devices 26-1 and 26-2 is captured do not overlap, but the ranges in which the plurality of videos is captured may overlap. In such a case, which video is used for the overlapping portion by the generation unit 202 is not particularly limited.

More specifically, the generation unit 202 may synthesize a plurality of videos to generate one video, and cut out a video seen by the user X in the VR space from the one video. Alternatively, the generation unit 202 may cut out a video seen by the user X in the VR space from each of the plurality of videos, and synthesize the plurality of videos after the cut-out.

The generation unit 202 also generates a video seen by the user X in the VR space from a plurality of videos for the user Y, as in the user X. The description of the example of FIG. 16 is ended.

As another method of generating a video that can be seen by the user from the plurality of videos, the generation unit 202 selects a video including a video that can be seen by the user in the VR space from the plurality of videos based on the positional relationship in the VR space between the user in the VR space and the window in the VR space. The generation unit 202 may cut out a video that the user in the VR space can see outside the window in the VR space from the selected video.

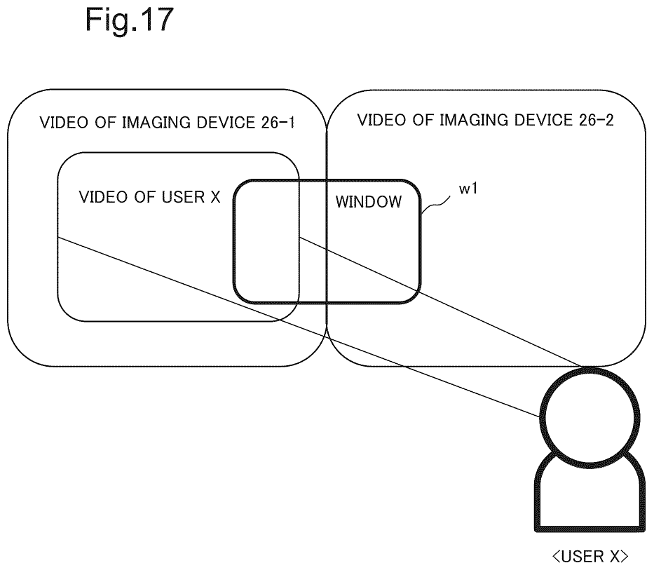

FIG. 17 is an explanatory diagram illustrating an example of selecting and generating a video of a window from videos captured by each of the plurality of imaging devices 26. In FIG. 17, the generation unit 202 generates a video seen by the user X in the VR space from the videos captured by the plurality of imaging devices 26 based on the positional relationship in the VR space between the user X in the VR space and the window w1 in the VR space and the line-of-sight orientation of the user in the VR space. Specifically, the generation unit 202 selects the video captured by the imaging device 26-1 from the video captured by the imaging device 26-2 and the video captured by the imaging device 26-1 based on the positional relationship in the VR space between the user X in the VR space and the window w1 in the VR space and the line-of-sight orientation of the user in the VR space. The generation unit 202 cuts out a video seen by the user X in the VR space from the selected video.

The description of the example of generating the video seen by the user in the VR space from the plurality of videos is ended. The generation processing described in a case where one imaging device 26 and the window are associated with each other and the generation processing described in a case where a plurality of imaging devices 26 and the window are associated with each other may be appropriately combined,

Next, the output control unit 203 displays the generated video in a frame in the VR space displayed on the display device. The display device is not particularly limited as described above, and examples thereof include the HMD 27 and the dome display 21. The dome display 21 is taken as an example of the display device.

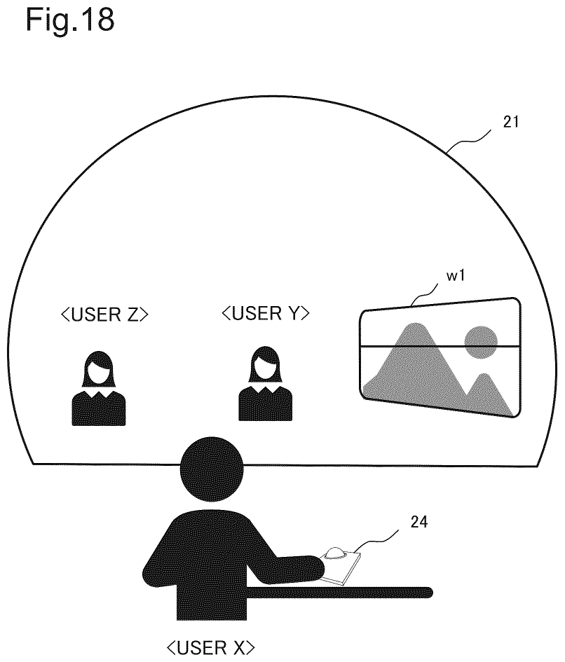

FIG. 18 is an explanatory diagram illustrating a display example of the dome display 21. For example, the dome display 21 displays a video of the inside of the vehicle in the VR space.

In FIG. 18, more specifically, for the user X, the user Y, the user Z, and the window w1 are displayed in the VR space on the dome display 21. In the VR space, the video generated by the generation unit 202 is displayed in the window w1.

### <Movement of User>

Next, a case where the user in the VR space moves will be described. For example, there are an example in which the user in the VR space is moved in conjunction with the movement of the user in the real space and an example in which the user in the VR space is moved by an operation by the user in the real space on an input device such as the controller 24 in the real space. Which example is used may be appropriately determined, and is not particularly limited. In a case where the display device is the HMD 27, there is a high possibility that any example will be used. For example, in a case where the display device is the dome display 21, there is a high possibility that the user in the VR space is moved by an operation on an input device such as the controller 24.

First, an example of interlocking with the movement of the user in the real space will be described.

At the start of use, the setting unit associates the position and the orientation of the user in the real space with the position and the orientation of the user in the VR space. The setting unit may store the associated information as a table in a storage means or the like.

Next, the detection unit 204 detects the movement of the user in the real space. The movement of the user in the real space includes movement of the face, movement of the head, movement of the body, and the like. More specifically, the movement of the user is to change the position of the face, the position of the head, the orientation of the face, the orientation of the head, the line-of-sight orientation, and the like. In a case where the display device is the HMD 27, the detection unit 204 may detect the movement of the user based on data detected by an acceleration sensor, a gyro sensor, a geomagnetic sensor, or the like provided in the HMD 27. In a case where the display device is the HMD 27 or the dome display 21, the detection unit 204 may detect the movement of the user from the image captured by the imaging device 22.

The identification unit 205 identifies a new position and orientation of the user in the VR space based on the detected movement of the user. For example, the amount of movement of the user in the real space and the amount of movement of the user in the VR space are proportional, and the magnification and the like are not particularly limited. For example, the movement amount of the user in the VR space may be several times the movement amount of the user in the real space.

Based on the positional relationship in the VR space between the new position of the user in the VR space and the window in the VR space and the new orientation of the user in the VR space, the generation unit 202 generates a new video of the window seen by the user in the VR space from the video captured by the imaging device 26 associated with the window.

Next, a case where the user in the real space moves the user in the VR space via the input device will be described as an example. For example, the reception unit 206 detects the movement of the user in the VR space by receiving the movement of the user in the VR space by the user's operation on the input device. The input device may be the controller 24, a terminal device, or the like, and is not particularly limited.

The identification unit 205 identifies a new position and orientation of the user in the VR space based on the received movement of the user in the VR space.

Based on the positional relationship in the VR space between the new position of the user in the VR space and the window in the VR space and the new orientation of the user in the VR space, the generation unit 202 generates a new video of the window seen by the user in the VR space from the video captured by the imaging device 26 associated with the window.

Based on the positional relationship in the VR space between the new position of the user in the VR space and the window in the VR space and the new orientation of the user in the VR space, the generation unit 202 generates a new video of the window seen by the user in the VR space from the video captured by the imaging device 26 associated with the window.

### <Graphic Display of Sound>

For example, in a VR space, a group travel by a vehicle may be performed. In the case of a group travel by a vehicle, the user is a traveler. In the case of the group travel, some users among the plurality of users may be known, but other users may not be known. In the group travel, there is an advantage that information can be shared by listening to a conversation or the like of a user who is not known, and there is a disadvantage that a conversation that is not interesting has to be listened.

Therefore, in the second example embodiment, the control system 20 may allow the user to selectively hear the sound.

Specifically, for example, the output control unit 203 displays, on the display device, a graphic representing the voice of another user other than the user, the another user having a conversation with the user. For example, the output control unit 203 may display the graphic together with the sound, or may mute the sound to display the graphic. For example, the generation unit 202 generates a video obtained by adding graphics representing voices of other users to the captured video. The output control unit 203 displays the generated video on the display device.

The graphic is a photograph, an illustration, a figure, a symbol, a character, or the like. The graphic may be a graphic related to the sound. The graphic according to the sound may be different in shape, size, color, pattern, and the like according to sound. Taking the color of the graphic as an example, the color of the sound related to travel and the color of the sound unrelated to travel may be different. For example, the output control unit 203 may highlight a graphic representing a sound related to travel, compared with a graphic representing a sound unrelated to travel. Similarly, in the case of a graphic pattern, a pattern of a sound related to travel and a pattern of a sound unrelated to travel may be different.

For example, another user other than the user, another user having conversation with the user, may be grouped in advance, or may be grouped according to the conversation. The grouped in advance means that users who travel together are registered in advance before the start of use, and the registered users who travel together are treated as one group. For example, the grouped according to the conversation means that when the user X, the user Y, and the user Z are having a conversation, the users included in the same conversation are grouped as one group. In this case, the group changes periodically.

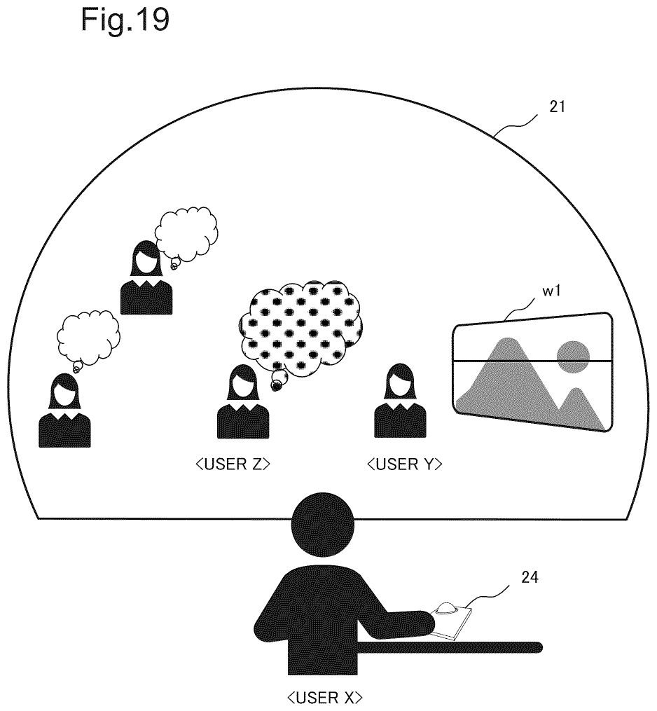

FIG. 19 is an explanatory diagram illustrating an example in which the voice of another user is displayed graphically. For example, in FIG. 19, balloons are used as graphics. The shape of the graphic is not limited to the shape of the balloon, and is not particularly limited as long as it can be identified that the graphic represents a sound.

In FIG. 19, there are three balloons. That is, in FIG. 19, there are three utterances or 3 groups of conversations. It is assumed that the user Z is a user who is not in conversation with the user X, and the voice of the user Z is a voice related to travel. On the other hand, it is assumed that voices of other users are voices not related to travel. For example, the output control unit 203 highlights a graphic representing a sound related to travel, compared with a graphic representing a sound unrelated to travel.

In FIG. 19, a graphic size and a pattern are used as highlighting. In FIG. 19, the size of a balloon representing the voice of the user Z is larger than the sizes of other balloons. The pattern of the balloon representing the voice of the user Z is a dot pattern, whereas the patterns of the other balloon sizes are plain. In this manner, the balloon representing the voice of the user Z is highlighted, compared with other balloons. A graphic color may be used as the highlight.

The reception unit 206 may receive selection of the graphic representing the sound according to an operation by the user. The operation by the user may be, for example, an operation via the input device, an operation according to the movement of the hand of the user, or an operation according to the voice of the user, and the operation method is not particularly limited. The input device is the controller 24, the terminal device, or the like as described above. The movement of the hand of the user can be detected from, for example, an image captured by the imaging device 26. The voice of the user is obtained by, for example, the recording device. The output control unit 203 outputs by sound the sound represented by the graphic selected by the user. Alternatively, for example, the output control unit 203 may not display the graphic selected by the user. Specifically, for example, the generation unit 202 adds a graphic other than the selected graphic to the captured video, and generates a video to which the selected graphic is not added. The output control unit 203 displays the generated video on the display device.

For example, in a case where the display device is the dome display 21 that does not cover the entire surface around the user, the output control unit 203 may output by voice a conversation behind the user and may display graphically a conversation in front of the user to be without outputting by sound. In front of the user is a direction in which the user faces, and behind the user is a direction opposite to the direction in which the user faces. The dome display 21 that does not cover the entire surface around the user is, for example, a 180 degree dome display 21.

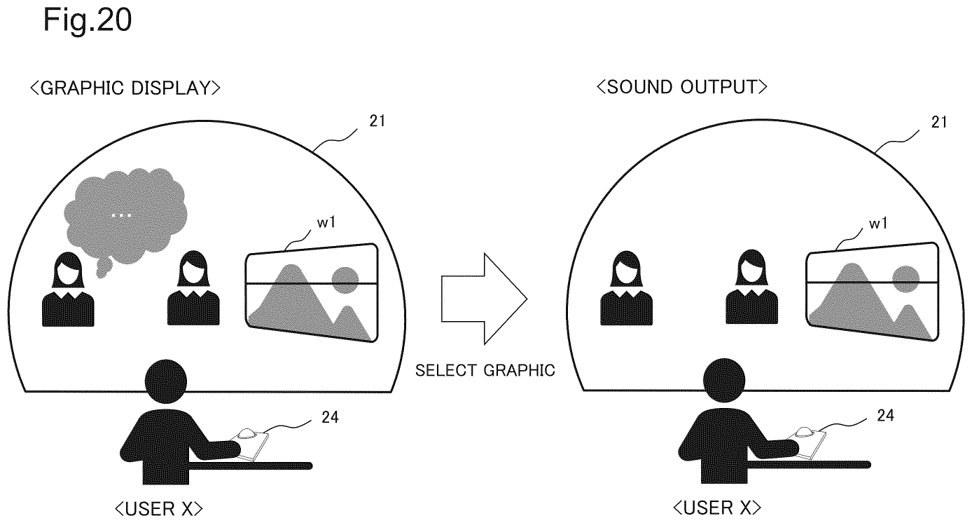

FIG. 20 is an explanatory diagram illustrating an example of switching from graphic output to sound output. For example, in FIG. 20, the output control unit 203 displays, on the dome display 21, a balloon representing the voice of the user Z. The reception unit 206 receives selection of the graphic by the operation by the user X. The output control unit 203 outputs by voice the voice of the user Z represented by the selected graphic.

The reception unit 206 may receive an output format of the voice of another user. The output control unit 203 outputs the voice of another user in the received output format. Specifically, for example, the reception unit 206 may be able to select the graphic representing the sound and the sound in stages. The reception unit 206 may also be able to select the graphic in stages. The output control unit 203 switches the output in stages. For example, the output control unit 203 may perform switching in such a way that more detailed content of the sound is displayed in stages such as a graphic representing a predetermined shape by color, a graphic representing the sound by characters, and the like.

The group travel is an example of a use scene. For example, the present invention can also be used in a use scene in a case where there is a plurality of users in a building.

The mobile object 25 may be a vehicle. For example, in a case where the mobile object 25 is a vehicle, the mobile object 25 may be installed outside a window of an actual vehicle, and the vehicle in the VR space may reproduce the actual vehicle. Another user displayed in the virtual reality space may be a person who is on an actual vehicle. In such a case, an imaging device that captures an image of the inside of the vehicle in the real space may be installed in the vehicle in the real space. The output control unit 203 may display a captured video of the inside of the vehicle as the inside of the vehicle in the virtual reality space displayed on the display device. In a case where the imaging device appears in the video inside, the generation unit 202 may generate a video corrected to delete the imaging device, and the output control unit 203 may display the generated video as a video of a vehicle in the virtual reality space.

### <Shopping>

For example, shopping may be performed during travel in the VR space.

The product determination unit 207 determines a recommended product from products included in the product DB 2003. The product included in the product DB 2003 is a product identified by the product identification information stored in the product DB 2003. Specifically, for example, the product determination unit 207 determines a product related to a travel destination as a recommended product. The product determination unit 207 may determine the recommended product based on the conversation of the user among the products related to the travel destination.

For example, the output control unit 203 presents information about the recommended product to the user. As a specific presentation method, the output control unit 203 may display, on the display device, the information about the recommended product, or may notify the terminal device of the user or the like of the information about the recommended product.

For example, the product may be sold in a form such as in-vehicle sales or in-flight sales. The output control unit 203 may display, on the display device, the avatar of the store clerk, and the avatar of the store clerk may present information about the recommended product.

The registration unit 208 receives the registration of the product by the operation by the user. The payment unit 209 performs settlement of the registered product by the operation by the user. An existing technique may be used as a product registration method and a settlement method.

### Flowchart

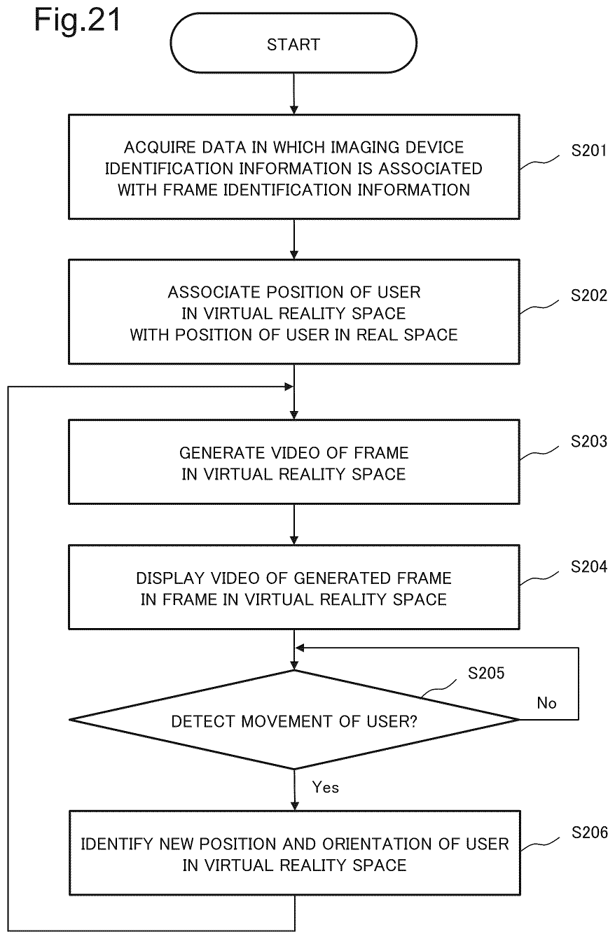

FIG. 21 is a flowchart illustrating an operation example of the control system 20 according to the second example embodiment. An example in which the movement of the user in the real space and the movement of the user in the VR space are interlocked will be described.

First, the acquisition unit 201 acquires data in which imaging device identification information for identifying the imaging device 26 installed in the real space is associated with frame identification information for identifying a frame in the VR space (step S201). For example, the acquisition unit 201 acquires the association table 2001 as this data.

The setting unit associates the position of the user in the VR space with the position of the user in the real space as initial setting (step S202).

Next, the generation unit 202 generates the video of the frame in the VR space from the video captured by the imaging device 26 associated with the frame in the VR space based on the positional relationship in the VR space between the frame in the VR space and the user in the VR space and the orientation of the user in the VR space (step S203). The output control unit 203 displays the generated video of the frame in the frame in the VR space (step S204).

The detection unit 204 determines whether the movement of the user in the real space has been detected (step S205). In a case where the movement of the user in the real space is not detected (step S205: No), the detection unit 204 returns the process to step S205.

In a case where the movement of the user in the real space is detected (step S205: Yes), the identification unit 205 identifies a new position and orientation of the user in the VR space (step S206), and the processing returns to step S203. As a result, a new video of a frame seen by the user in the VR space at the new position and orientation of the user in the VR space is generated.

The flowchart may be appropriately ended.

In the second example embodiment, the control system 20 cuts out a video of a frame seen by the user in the VR space from the video captured by the imaging device 26. As a result, it is possible to provide a video outside the frame that can be seen by the user in the VR space. Alternatively, based on the positional relationship in the VR space between the user in the VR space and the frame in the VR space, the control system 20 generates a new video of a frame seen by the user in the VR space from the video captured by the imaging device 26. As a result, it is possible to provide a video outside the frame that can be seen by the user in the VR space. It is possible to complement a video that is not included in actual experience.

In a case where a plurality of imaging devices 26 installed at different positions is associated with a frame, the control system 20 generates a video of the frame seen by the user in the VR space from the plurality of videos. As a result, it is possible to provide a video outside the frame that can be seen by the user in the VR space.

The control system 20 generates, for each of the plurality of users, a video of a frame seen by the user in the VR space from the video captured by the imaging device 26 based on the positional relationship in the VR space between the user in the VR space and the frame in the VR space. As a result, even when there is a plurality of users in the VR space, it is possible to provide a video related to the position of the user in the VR space from the video captured by the same imaging device 26 installed in the real space.

The control system 20 generates a new video of a frame seen by the user in the VR space based on the positional relationship in the VR space between the user in the VR space and the frame in the VR space and the orientation of the user in the VR space. As a result, since the video differs depending on the orientation of the user, a more realistic video can be provided.

The control system 20 detects the movement of the user in the real space, and identifies the position and the orientation of the user in the VR space based on the movement of the user in the real space. The control system 20 generates a new video of a frame seen by the user in the VR space based on the positional relationship in the VR space between the user in the VR space at the identified position and the frame in the VR space and the new orientation. As a result, since the video changes depending on the vertical movement of the user in the real space, the horizontal movement of the user, and the like, it is possible to improve the realistic feeling of the video seen outside the frame.

The control system 20 receives movement of the user in the VR space by the operation by the user in the real space. Based on the received movement, the control system 20 identifies a position and an orientation of a user in a VR space, and generates a new video of a frame seen by a user in the VR space based on the positional relationship in the VR space between the user in the VR space and the frame in the VR space at the identified position and the new orientation of the user in the VR space. Thereby, the video changes depending on the vertical movement of the user, the horizontal movement of the user, and the like, so that it is possible to improve the realistic feeling of the image seen outside the frame.

The frame is a window or a door. For example, the window may be a vehicle window or a building window. As a result, the scene viewed from the vehicle window in the VR space can be changed according to the position of the user in the VR space. A scene viewed from a window of a building in the VR space can be changed according to a position of a user in the VR space. Similarly, the door may be a vehicle window or a building door. As a result, it is possible to improve the realistic feeling of the video seen outside the window or the door. In the case of the door, when the door is open, control system 20 may display the generated video in the door.

The imaging device 26 may be installed in the mobile object 25 in the real space. For example, as the mobile object 25 moves, the video captured by the imaging device 26 also changes. For example, a scene viewed from a window of a building or a vehicle changes according to movement of the mobile object 25. Thereby, a travel experience or the like can be provided. The mobile object 25 may move in real time. Thereby, a real-time video can be provided.

The control system 20 displays a voice of another user, other than the user, having a conversation with the user in graphics. The user wants to enjoy a realistic image, or to enjoy a group travel on a vehicle when it is a travel. The user may or may not want to listen to another user who get on the vehicle. For example, when the information is useful for the user, the user wants to listen to the information. As a result, for example, when the user does not view the graphic, the user does not mind the conversation of another user. On the other hand, if the user is interested, the user may view the graphic. As described above, the control system 20 can provide a better video experience by combining the goodness of real travel and the goodness of VR space.

The control system 20 outputs by sound the sound represented by the graphic selected by the user from among the displayed graphics. For example, the user can confirm by sound a conversation in which the user is interested.

The control system 20 does not display the graphic selected by the user among the graphics. As a result, the user can erase the graphic representing the conversation in which the user is not interested from the field of view.

In a case where the display device is the hemispherical dome display 21, the control system 20 may output by voice a conversation behind the user in the VR space, and may display a conversation in front of the user in the VR space graphically.

The control system 20 can receive an output format of the voice of another user, to output the voice of another user in received output format. For example, the control system 20 can select the output format stepwise in the order of color, character, and sound. As a result, the output format of the conversation of another user can be changed according to the interest of the user.

The description of each example embodiment is ended. The example embodiments may be used in combination as appropriate.

In each example embodiment, the control system 20 may include each functional unit and part of information. In the second example embodiment, the example in which the control system 20 has some functions of a point of sale (POS) system such as the registration unit 208 and the payment unit 209 has been described. The POS system including the registration unit 208 and the payment unit 209 and the control system 20 may be connected via a communication network.

The example embodiments are not limited to the examples described above, and various modifications can be made. The configuration of the control system 20 in each example embodiment is not particularly limited. For example, the control system 20 may be achieved by one device such as one server. In a case where each functional unit of the control system 20 is achieved by one device, for example, one device may be referred to as a control device, an information processing device, or the like, and is not particularly limited. Alternatively, the control system 20 in each example embodiment may be achieved by a different device for each function or data. For example, each functional unit may be configured by a plurality of servers and implemented as the control system 20. For example, the control system 20 may be achieved by a database server including each DB and a server including each functional unit.

In each example embodiment, each piece of information and each DB may include part of the information described above. Each piece of information and each DB may include information other than the above-described information. Each piece of information or each DB may be divided into a plurality of DBs or a plurality of pieces of information in more detail. As described above, a method of achieving each piece of information and each DB is not particularly limited.

Each screen is an example, and is not particularly limited. In each screen, a button, a list, a checkbox, an information display field, an input field, and the like (not illustrated) may be added. The background color of the screen and the like may be changed.

The processing of generating information or the like to be displayed on the display device may be performed by the output control unit 103, 203. This processing may be performed by a display device.

### Hardware Configuration Example of Computer

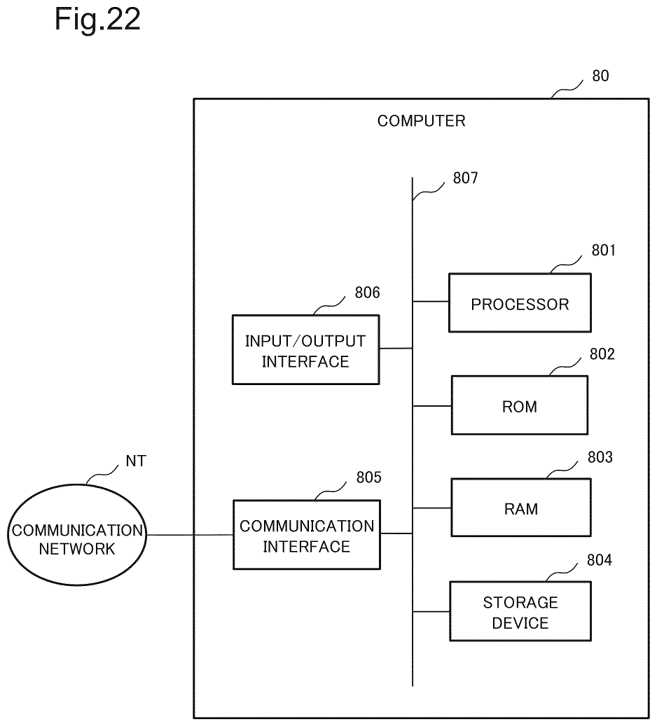

Next, a hardware configuration example in a case where each device in the control system 10, 20 described in each example embodiment is achieved by a computer will be described. FIG. 22 is an explanatory diagram illustrating a hardware configuration example of a computer. For example, part or all of each device can be achieved by using an any combination of a computer 80 and the program as illustrated in FIG. 22.

The computer 80 includes, for example, a processor 801, a read only memory (ROM) 802, a random access memory (RAM) 803, and a storage device 804. The computer 80 includes a communication interface 805 and an input/output interface 806. The components are connected via a bus 807. The number of each component is not particularly limited, and each component is one or more.

The processor 801 controls the entire computer 80. Examples of the processor 801 include a central processing unit (CPU), a digital signal processor (DSP), and a graphics processing unit (GPU). The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. The RAM 803 is used as a work area of the processor 801.

The processor 801 loads a program stored in the storage device 804, the ROM 802, or the like. The processor 801 executes each process coded in the program. The processor 801 may download various programs via the communication network NT. The processor 801 functions as part or all of the computer 80. The processor 801 may execute processes or instructions in the flowchart illustrated based on the program.

The communication interface 805 is connected to the communication network NT such as a local area network (LAN) or a wide area network (WAN) through a wireless or wired communication line. The communication network NT may include a plurality of communication networks NT. As a result, the computer 80 is connected to an external device or an external computer 80 via the communication network NT. The communication interface 805 manages an interface between the communication network NT and the inside of the computer 80. The communication interface 805 controls an input/output of data from the external device or the external computer 80.

The input/output interface 806 is connected to at least any one of an input device, an output device, and an input/output device. The connection method may be wireless or wired. Examples of the input device include a keyboard, a mouse, and a microphone. Examples of the output device include a display device, a lighting device, and a sound output device that outputs a sound. Examples of the input/output device include a touch panel display. The input device, the output device, the input/output device, and the like may be built in the computer 80 or may be externally attached.

The hardware configuration of the computer 80 is an example. The computer 80 may have some components illustrated in FIG. 22. The computer 80 may have components other than those illustrated in FIG. 22. For example, the computer 80 may include a drive device or the like. The processor 801 may read a program or data stored in a recording medium attached to a drive device or the like into the RAM 803. Examples of the non-transitory tangible recording medium include an optical disk, a flexible disk, a magnetic optical disk, and a Universal Serial Bus (USB) memory. As described above, for example, the computer 80 may include an input device such as a keyboard and a mouse. The computer 80 may include an output device such as a display. The computer 80 may include an input device, an output device, and an input/output device.

The computer 80 may include various sensors (not illustrated). The type of the sensor is not particularly limited. The computer 80 may include an imaging device capable of capturing images and videos.

The description of the hardware configuration of each device is ended. There are various modifications in a method of achieving each device. For example, each device may be achieved by an any combination of a computer and a program different for each component. A plurality of components included in each device may be achieved by any combination of one computer and a program.

Part or all of each component of each device may be achieved by an application specific circuit. Part or all of each component of each device may be achieved by a general-purpose circuit including a processor such as a field programmable gate array (FPGA). Part or all of each component of each device may be achieved by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where part or all of each component of each device is achieved by a plurality of computers, circuits, and the like, the plurality of computers, circuits, and the like may be disposed in a centralized manner or in a distributed manner.

The control methods described in the example embodiments are implemented by the control system 10, 20. For example, the control method is implemented by a computer such as a server or a terminal device executing a program prepared in advance.

The program described in each example embodiment is recorded in a computer-readable recording medium such as an HDD, an SSD, a flexible disk, an optical disk, a magnetic optical disk, and a USB memory. The program is executed by being read from the recording medium by the computer. The program may be distributed via the communication network NT.

Each component of the control system 10, 20 in each example embodiment described above may be achieved by dedicated hardware such as a computer. Alternatively, each component may be achieved by software. Alternatively, each component may be achieved by a combination of hardware and software.

While the present disclosure has been particularly shown and described with reference to each of example embodiments, the present disclosure is not limited to the above example embodiments. The configurations and details of the present disclosure may include example embodiments to which various changes that can be grasped by those of ordinary skill in the art without departing from the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

A control system including
an acquisition means for acquiring data in which imaging device identification information for identifying an imaging device installed in a real space is associated with frame identification information for identifying a frame in a virtual reality space,
a generation means for generating, from a video captured by an imaging device identified by the imaging device identification information associated with the frame identification information for identifying the frame based on a positional relationship in the virtual reality space between a user in the virtual reality space and the frame, a video of the frame seen by the user in the virtual reality space, and
an output control means for displaying the generated video of the frame in the frame displayed on a display device.

### Supplementary Note 2

The control system according to Supplementary Note 1, wherein
the generation means cuts out the video of the frame seen by the user in the virtual reality space from the video captured by the imaging device based on the positional relationship in the virtual reality space between the user in the virtual reality space and the frame.

### Supplementary Note 3

The control system according to Supplementary Note 1, wherein
the generation means generates a new video of the frame seen by the user in the virtual reality space from the video captured by the imaging device based on a positional relationship in the virtual reality space between the user in the virtual reality space and the frame.

### Supplementary Note 4

The control system according to any one of Supplementary Notes 1 to 3, wherein
the acquisition means acquires data in which imaging device identification information for identifying each of a plurality of imaging devices installed at different positions is associated with the frame identification information for identifying the frame, and
the generation means generates the video of the frame seen by the user in the virtual reality space from a plurality of videos captured by the plurality of imaging devices identified by the plurality of imaging device identification information associated with the frame identification information for identifying the frame based on the positional relationship in the virtual reality space between the user in the virtual reality space and the frame.

### Supplementary Note 5

The control system according to any one of Supplementary Notes 1 to 4, wherein
the generation means generates, for each of a plurality of users, a video of the frame seen by the each user in the virtual reality space from the video captured by the imaging device based on a positional relationship in the virtual reality space between a position of the each user in the virtual reality space and the frame.

### Supplementary Note 6

The control system according to any one of Supplementary Notes 1 to 5, wherein
the generation means generates a new video based on a positional relationship in the virtual reality space between the user and the frame in the virtual reality space and an orientation of the user in the virtual reality space.

### Supplementary Note 7

The control system according to any one of Supplementary Notes 1 to 6, further including
a setting means for associating a position and an orientation of the user in the real space with a position and an orientation of the user in the virtual reality space,
a detection means for detecting movement of the user in the real space, and
an identification means for identifying a position and an orientation of the user in the virtual reality space based on the movement of the user in the real space, wherein
the generation means generates a new video based on a positional relationship in the virtual reality space between the user in the virtual reality space at the identified position and the frame and the identified orientation.

### Supplementary Note 8

The control system according to any one of Supplementary Notes 1 to 7, further including
a reception means for receiving movement of the user in the virtual reality space by an operation by the user in the real space, and
an identification means for identifying a position and an orientation of the user in the virtual reality space based on the received movement, wherein
the generation means generates a new video based on a positional relationship in the virtual reality space between the user in the virtual reality space at the identified position and the frame, and the identified orientation.

### Supplementary Note 9

The control system according to any one of Supplementary Notes 1 to 8, wherein
the frame is a window or a door.

### Supplementary Note 10

The control system according to Supplementary Note 9, wherein
the window is a vehicle window or a building window, and
the door is a vehicle door or a building door.

### Supplementary Note 11

The control system according to Supplementary Note 10, wherein
the imaging device is installed at a mobile object in the real space.

### Supplementary Note 12

The control system according to any one of Supplementary Notes 1 to 11, wherein
the output control means displays a graphic representing a voice of another user other than a user having a conversation with the user in the virtual reality space.

### Supplementary Note 13

The control system according to Supplementary Note 12, further including
a reception means for receiving, from among a plurality of the graphics, selection of a graphic by the user in the real space, wherein
the output control means outputs by sound a sound represented by the selected graphic.

### Supplementary Note 14

The control system according to Supplementary Note 12, further including
a reception means for receiving, from among a plurality of the graphics, selection of a graphic by the user in the real space, wherein
the output control means does not display the selected graphic.

### Supplementary Note 15

The control system according to any one of Supplementary Notes 12 to 14, wherein
in a case where the display device is a hemispherical dome-shaped display,
the output control means outputs by voice a conversation behind the user in the virtual reality space and displays a conversation in front of the user in the virtual reality space graphically.

### Supplementary Note 16

The control system according to any one of Supplementary Notes 12 to 14, further including
a reception means for receiving an output format of a voice of the another user, wherein
the output control means outputs the voice of the another user in a received output format.

### Supplementary Note 17

A control method including
acquiring data in which imaging device identification information for identifying an imaging device installed in a real space is associated with frame identification information for identifying a frame in a virtual reality space,
generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame, and
displaying the generated video of the frame in the frame displayed on a display device.

### Supplementary Note 18

A non-transitory computer-readable recording medium that records a program, the program causing a computer to execute the steps of
acquiring data in which imaging device identification information for identifying an imaging device installed in a real space is associated with frame identification information for identifying a frame in a virtual reality space,
generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame, and
displaying the generated video of the frame in the frame displayed on a display device.

### Supplementary Note 19

A program causing a computer to execute the steps of
acquiring data in which imaging device identification information for identifying an imaging device installed in a real space is associated with frame identification information for identifying a frame in a virtual reality space,
generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame, and
displaying the generated video of the frame in the frame displayed on a display device.

### REFERENCE SIGNS LIST

10, 20 control system
21 dome display
22 imaging device
23 recording device
24 controller
25 mobile object
26, 26-1, 26-2 imaging device
80 computer
101, 201 acquisition unit
102, 202 generation unit
103, 203 output control unit
204 detection unit
205 identification unit
206 reception unit
207 product determination unit
208 registration unit
209 payment unit
801 processor
802 ROM
803 RAM
804 storage device
805 communication interface
806 input/output interface
807 bus
2101 screen
2102 projection device
2001 association table
2002 user DB
2003 product DB
NT communication network
w1 window
X user
Y user
Z user

What is claimed is:

1. A control system comprising:
a memory storing instructions; and
at least one processor configured to execute the instructions to:
acquire data in which imaging device identification information for identifying an imaging device installed in a real space is associated with frame identification information for identifying a frame in a virtual reality space;
generate, from a video captured by an imaging device identified by the imaging device identification information associated with the frame identification information for identifying the frame based on a positional relationship in the virtual reality space between a user in the virtual reality space and the frame, a video of the frame seen by the user in the virtual reality space; and
display the generated video of the frame in the frame displayed on a display device.

2. The control system according to claim 1, wherein the at least one processor is further configured to execute the instructions to:
cut out the video of the frame seen by the user in the virtual reality space from the video captured by the imaging device based on the positional relationship in the virtual reality space between the user in the virtual reality space and the frame.

3. The control system according to claim 1, wherein the at least one processor is further configured to execute the instructions to:
generate a new video of the frame seen by the user in the virtual reality space from the video captured by the imaging device based on the positional relationship in the virtual reality space between the user in the virtual reality space and the frame.

4. The control system according to claim 1, wherein the at least one processor is further configured to execute the instructions to:
acquire data in which imaging device identification information for identifying each of a plurality of imaging devices installed at different positions is associated with the frame identification information for identifying the frame, and
generate the video of the frame seen by the user in the virtual reality space from a plurality of videos captured by the plurality of imaging devices identified by the plurality of imaging device identification information associated with the frame identification information for identifying the frame based on the positional relationship in the virtual reality space between the user in the virtual reality space and the frame.

5. The control system according to claim 1, wherein the at least one processor is further configured to execute the instructions to:
generate, for each of a plurality of users, a video of the frame seen by the each user in the virtual reality space from the video captured by the imaging device based on a positional relationship in the virtual reality space between a position of the each user in the virtual reality space and the frame.

6. The control system according to claim 1, wherein the at least one processor is further configured to execute the instructions to:
generate a new video based on a positional relationship in the virtual reality space between the user and the frame in the virtual reality space and an orientation of the user in the virtual reality space.

7. The control system according to claim 1, the at least one processor is further configured to execute the instructions to:
associate a position and an orientation of the user in the real space with a position and an orientation of the user in the virtual reality space;
detect movement of the user in the real space; and
identify a position and an orientation of the user in the virtual reality space based on the movement of the user in the real space, wherein
generate a new video based on a positional relationship in the virtual reality space between the user in the virtual reality space at the identified position and the frame and the identified orientation.

8. The control system according to claim 1, the at least one processor is further configured to execute the instructions to:
receive movement of the user in the virtual reality space by an operation by the user in the real space; and
identify a position and an orientation of the user in the virtual reality space based on the received movement, wherein
generate a new video based on a positional relationship in the virtual reality space between the user in the virtual reality space at the identified position and the frame, and the identified orientation.

9. The control system according to claim 1, wherein
the frame is a window or a door.

10. The control system according to claim 9, wherein
the window is a vehicle window or a building window, and
the door is a vehicle door or a building door.

11. The control system according to claim 10, wherein
the imaging device is installed at a mobile object in the real space.

12. The control system according to claim 1, wherein the at least one processor is further configured to execute the instructions to:
display a graphic representing a voice of another user other than a user having a conversation with the user in the virtual reality space.

13. The control system according to claim 12, wherein the at least one processor is further configured to execute the instructions to:
receive, from among a plurality of the graphics, selection of a graphic by the user in the real space, wherein
output by sound a sound represented by the selected graphic.

14. The control system according to claim 12, wherein the at least one processor is further configured to execute the instructions to:
receive, from among a plurality of the graphics, selection of a graphic by the user in the real space, wherein
do not display the selected graphic.

15. The control system according to claim 1, wherein the at least one processor is further configured to execute the instructions to:
in a case where the display device is a hemispherical dome-shaped display,
output by voice a conversation behind the user in the virtual reality space and displays a conversation in front of the user in the virtual reality space graphically.

16. The control system according to claim 1, the at least one processor is further configured to execute the instructions to:
receive an output format of a voice of the another user, wherein
output the voice of the another user in the received output format.

17. A control method comprising:
acquiring data in which imaging device identification information for identifying an imaging device installed in a real space is associated with frame identification information for identifying a frame in a virtual reality space;
generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame; and
displaying the generated video of the frame in the frame displayed on a display device.

18. A non-transitory computer-readable recording medium that records a program, the program causing a computer to execute the steps of:
acquiring data in which imaging device identification information for identifying an imaging device installed in a real space is associated with frame identification information for identifying a frame in a virtual reality space;
generating, based on a positional relationship in the virtual reality space between a user in the virtual reality space and the frame, a video of the frame seen by the user in the virtual reality space from a video captured by an imaging device identified by the imaging device identification information associated with the frame identification information for identifying the frame; and
displaying the generated video of the frame in the frame displayed on a display device.
